(19) United States
(12) Patent Application Publication
(10) Pub. No.: US 2010/0058181 A1
(43) Pub. Date: Mar. 4, 2010

(54) RECORDING, PLAYBACK, AND DISTRIBUTION OF DASHBOARD INTERACTIONS INCLUDING ANNOTATIONS

(75) Inventors: Vijay Krishnan Ganesan, Fremont, CA (US); James Paul Rogers, Eden Prairie, MN (US)

Correspondence Address: MARGER JOHNSON & MCCOLLOM, P.C. - Oracle;(ORACLE), 210 SW MORRISON STREET, SUITE 400, PORTLAND, OR, 97204, US

(73) Assignee: ORACLE INTERNATIONAL CORPORATION, Redwood Shores, CA (US)

(21) Appl. No.: 12/198,775

(22) Filed: Aug. 26, 2008

(51) Int. Cl. G06F 3/048

(52) U.S. Cl. 715/700

(57) ABSTRACT

An interaction tracking facility records, stores, plays back, distributes and allows recipients to interject new events into a stored set of discrete interaction events of a dashboard. A recorder stores data that identifies dashboard annotation and analysis events so that they can be later retrieved and played back. During playback, the stored events are executed, in stepwise fashion, in another dashboard, recreating the events recorded on the first dashboard as if they were performed on the second dashboard. The second dashboard can be coupled to different data than the original dashboard without changing the stored events. Events are stored in a repository and identified by a URL, which can be sent to a recipient for retrieval. The playback can be stopped at any time, and a branch recording created with a second set of interaction events that are different from or additional to the original recording events.

### BACKGROUND

A Business Intelligence Dashboard presents relevant information or data from a data source to a user through a graphical interface. The best dashboards convey information in a simple, easy to use manner. Various menus allow the user to select particular areas of interest, present desired information in a variety of ways, and drill-down to see underlying data. In typical systems, the dashboard actively updates itself with updated screens as its underlying data changes, but some elements of the dashboard may be static as well.

In addition to simply viewing the data, users may also have an ability to interact with it. For example, users may set parameterized values for data filtering, change the type of visualization of a data set, invoke an external action including passing current data context, navigate to related content, and change the layout of displayed views, among other actions.

During interactive dashboard analysis, a user may annotate the content being analyzed, for the user's own benefit at a later time, or for the benefit of another user. The annotations could be in fixed-form, such as text, audio, or video notes associated with a cell in a table. Conversely, the annotation could be in free-form, such as drawing a shape around a set of data points of interest on a chart, or typing some text within a view area, such as a text box.

Users may share analysis with others who are analyzing the same or different information content. To facilitate sharing, a user records an analysis with a screen recorder, saves it in a repository, then distributes the recording to the desired recipients. Oftentimes recipients of the recordings have problems using the recording. In many cases, the large size of screen recordings makes them difficult to store and send over conventional communication networks. Even if the recording is properly delivered, the recipients may not have a compatible playback system. Others may wish to add their own annotations in the playback, which is very difficult to do in present-day screen recorders. Further, because screen recorders capture “snapshots” of the display, the recording is out of date as soon as the dashboard or its underlying data changes.

### BRIEF DESCRIPTION OF THE DRAWINGS

FIG. 1 is a screen diagram showing data presented in a conventional dashboard view.

FIG. 2 is a functional block diagram of a dashboard interaction tracking facility coupled to a dashboard system, according to of embodiments of the invention.

FIG. 3 is a screen diagram illustrating a dashboard operating in conjunction with a screen interaction tracking facility according to embodiments of the invention.

FIG. 4 is a screen diagram showing a comparison mode of the interaction tracking facility operating on a dashboard.

FIG. 5 is an example flow diagram illustrating processes used in recording an annotation, according to embodiments of the invention.

### DETAILED DESCRIPTION OF THE EMBODIMENTS

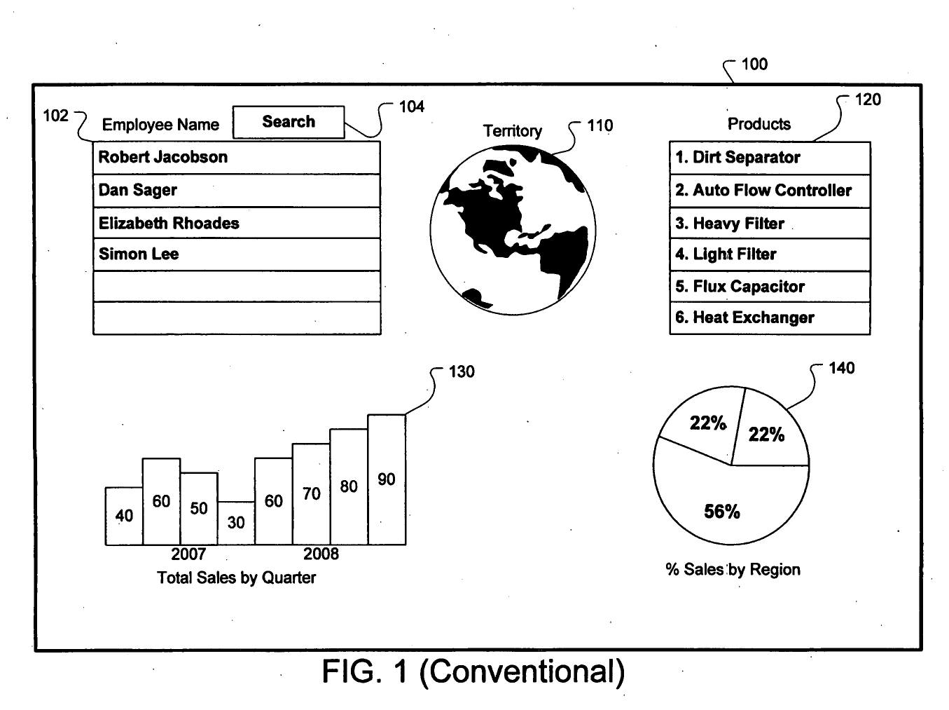

A typical dashboard screen 100 is illustrated in FIG. 1. The dashboard 100 includes multiple elements, also known as features or ‘widgets’ that display particular views of various data spread across the screen. Although dashboards 100 are usually customizable, they are typically pre-formatted with particular widgets for particular industries or functions. For example a financial dashboard may have a very different layout than a dashboard specific to human resources. The dashboard 100 of FIG. 1 is specific to sales information, and has several widgets related to information that is relevant for a sales manager. Embodiments of the invention are, of course, applicable to all types of dashboards or other similar data presentation vehicles.

An employee list widget 102 is in the upper left had of the dashboard 100. The employee list widget 102 displays lists of employees able to be selected by the user. Employee data that populates the employee list widget 102 is stored in and retrieved from a data repository (not illustrated) coupled to the dashboard 100. The data repository may be tied in to a data store for a human resources department, so that, when employees are added or deleted, the employee list widget 102 is automatically updated. A search field 104 in the list widget 102 provides the user with a facility for locating particular employees. Once an employee is located and selected, data specific for the particular employee populates the other widgets in the dashboard 100.

A map widget 110 graphically illustrates sales territories covered by the selected employee. As the employee is given responsibility for additional or fewer territories, the map widget 110 automatically updates the dashboard 100 with such information. A products widget 120 displays which products the employee sells. Selecting a particular product by clicking in the products widget 120 brings up sales information in a sales widget 130, which shows quarterly sales of the selected product(s) by the selected employee. Selecting additional products in the products widget 120 updates the sales widget 130 in real time. The dashboard 100 additionally includes a region sales graph widget 140, which graphically shows the sales per region of the selected employee.

In operation, a user interacts with the dashboard 100 to learn information about the selected employee. Each of the widgets 102, 120, 130, 140 may include various ways to present the information to the user. For instance the sales graph widget 140 may include an ability to present the same information in a bar graph or in spreadsheet form. Additionally, the dashboard 100 may include a pallet of other widgets (not illustrated) that can be added by the user for display in the dashboard, each of which may be customized by the user.

In an example interaction, the user selects an employee from the employee list widget 102, filters the products to show only those that have generated over $1M in total sales, selects particular filtered products in the products widget 120, changes the region sales graph widget 140 to a spreadsheet form, then launches a report to be printed using data from the spreadsheet.

As described above, a user may record the above actions by recording the screen while the user is performing such actions, then send the recorded screen to a recipient using conventional file delivery.

Embodiments of the invention instead work much differently, and give increased flexibility to the user and to the recipient, as described below. An interaction tracking facility includes a recorder that stores a series of events as discrete event data. Each event, such as the selecting, filtering, changing, and reporting events described above, are coded and stored by an event recorder in a permanent data store. Note that these events correspond to and are preferably captured and recorded as dashboard interactions, but may also include, in some situations, lower-level system events such as keystrokes and mouse movements. The event data is generated by the event recorder in a format such as Extensible Markup Language (XML), or any other acceptable format. Event data is different than and separate from the data used to populate the dashboard 100, which remains unchanged by the event recorder.

The event recorder records event data as the dashboard 100 user performs steps. For example, and with reference to the example above, a first recorded step or event can be clicking a button on the dashboard 100 to search for and select an employee. A second recorded step can be a filtering step such as selecting only those products with greater than $1M in annual sales to be shown in the products widget 120. A third step can be selecting the particular products to be included in the sales graph widget 140. A next recorded step can be changing the data presentation in the region sales graph widget 140 to a list form. A further step can be navigating away from the dashboard 100, but still using the underlying data, such as printing a set of pre-selected reports using the data that was filtered in the second step and formatted in the third step.

Each of these action steps is a separate event, created with data in the event recorder so that it can be re-created by another dashboard during playback. During playback, as the underlying data in the database changes, the outcome likewise changes, but the recorded events are identical. For instance, running the annotation in February may filter out all products because none have exceeded the $1M annual sales threshold. Running the annotation in November may have a very different outcome (generated report) because the underlying data changed and more products exceeded the filter threshold. In both cases the annotation was exactly the same, only the underlying data changed.

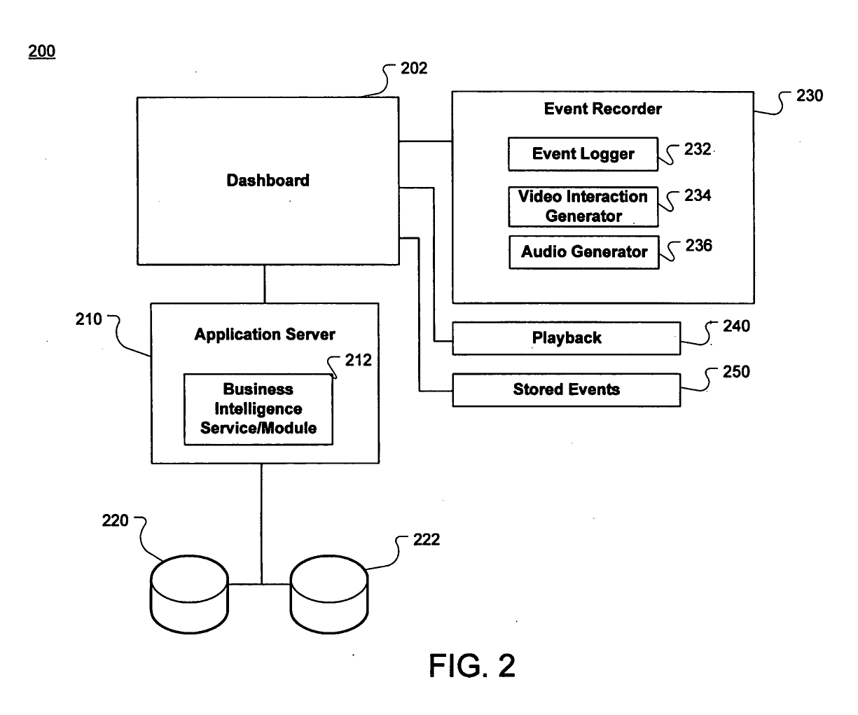

FIG. 2 shows the components of an annotation system 200 according to embodiments of the invention. The annotation system 200 includes a dashboard 202, which may be the same or different than the dashboard 100 of FIG. 1. The dashboard 202 is coupled to an application server 210 hosting the business intelligence services 212. The application server is in turn coupled to databases 220, 222 such as an Oracle® DBMS Server. The databases 220, 222 store the information accessed by the business intelligence server 210, which in turn provides the retrieved data to the dashboard 202. The application server 210 may host services other than the business intelligence service. For instance, the application server 210 may run a sales application that updates the databases 220, 222 as sales are recorded.

An event recorder 230 may include sub-components. An event logger 232 was described above, and records analysis and/or annotation events. Additionally the event recorder 230 includes a video data generator 234 and an audio data generator 236 as described below.

Other elements of the annotation system 200 include a playback unit 240 and a repository 250 for stored annotations, both of which are described in detail below.

In operation, with reference to FIG. 2, a user invokes the event recorder 230 to record an annotation an/or analysis. The event recorder 230 generates and accumulates data defining the event as the annotation proceeds.

Recorded events may include analysis events, such as filtering data, or annotation events, such as highlighting or adding text to the screen. As used in this description, for brevity, annotation and analysis events are both referred to as events or annotation events.

As described below, any video data and/or audio data are generated by the video generator 234 and audio generator 236, respectively, and are associated with the particular event to which they relate. When the annotation is complete, it is stored either in the permanent repository 250, or in one or both of the databases 220, 222 for retrieval and playback. A unique address points to the particular stored annotation, which can be sent as a pointer such as a Uniform Resource Locater (URL), or selected from a list of stored annotations.

As illustrated in FIG. 2, the event recorder 230 works in conjunction with the dashboard 202, which in some embodiments is web browser based. As such the dashboard 202 operates using Hyper-Text Markup Language (HTML) or Dynamic HTML (DHTML) as an input. The event recorder 230 may be implemented in any appropriate language or system, such as, for instance, in the Java™ programming language by Sun®,C++, JavaScript and/or ActionScript. The output of the event recorder 230 may include the XML data described above. Further, screen annotation actions, such as highlighting, circling with a free-hand tool or creating a text box may be implemented using the Flex application development framework for the Flash player, both by Adobe®. The Flex application development framework is a framework for building web and desktop applications that run in the Flash Player.

Particular screen event annotations may be “fixed” to a particular element within a widget, such as a cell within a spreadsheet, or may be “free.” An example of a free annotation event is a circle drawn around a particular widget or group of data within a widget. The event recorder 230 captures these drawing annotation events, which may be related or associated to other events, such as changing a widget format. For example, if a user launched a report from spreadsheet widget, the user may write a text note on the screen for the benefit of the recipient of the annotation to describe the contents of the report. In such a case, the event recorder 230 stores, in XML, the report launching event, and also stores, using the Flex framework described above, the text box. Each of these actions is related to the particular annotation event in sequence, so that, during playback, the proper events happen in the correct order and at the correct time.

The event recorder 230 records and stores fixed form annotation events relative to the location of the data cell with which they are associated. Free annotation events may be recorded relative to the boundaries of the view containing the annotation.

Further, audio or video clips or files may be associated with annotation events. For example, the user may describe each annotation event as the analysis progresses. The event recorder 230 also associates such media clips to the particular annotation events to which they relate. Audio/video clips may be in a multimedia format that can be player by the Flash player or other players.

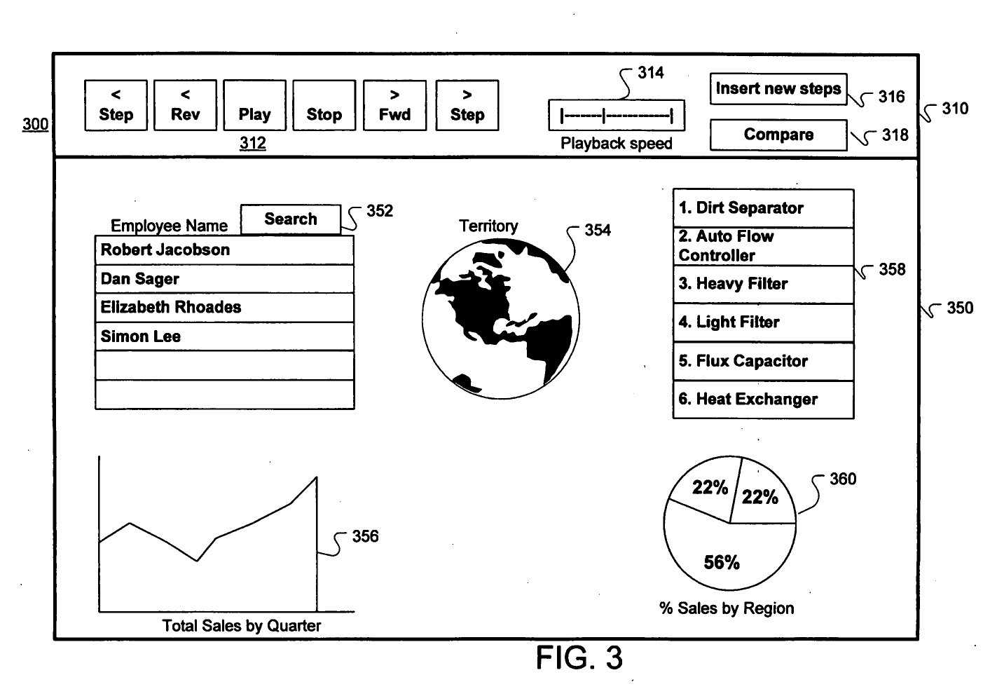

FIG. 3 is a screen diagram that illustrates playback functions of the interaction tracking facility. A playback system 300 includes a recording running in playback mode, including a playback unit 310 coupled to a dashboard 350. The dashboard 350 is typically the same dashboard that was used to create the recording currently being played, although any dashboard that is compatible with the played recording would suffice.

A user invokes a recording playback by navigating to its stored location. For instance, because the annotation has a unique address, its URL specifies its location, much as a webpage is identified. A user selects a particular recording by clicking on its link or selecting it from a list of stored locations, or in another manner. Selecting the URL starts the playback unit 310, which loads the appropriate dashboard 350. In some embodiments, if the original dashboard is unavailable, the playback unit 310 will signal the user and determine whether to proceed with a substitute dashboard.

The playback unit 310 includes control buttons 312, such as play, stop, forward, and reverse. Also, because each interaction event is a discrete event, such interaction events may be individually “stepped,” either forward or backward, and control buttons 312 give the user this option as well. Further, a speed adjust 314 provides the user opportunity to control the playback speed, i.e., the speed of the events and, if very slow playback is selected, a pause between events as they are played back. Finally, an insert button 316 allows the user to insert a new event at a particular location in the recording, which then becomes its own new recording. New recordings are stored in the repository 250 (FIG. 2) or in the databases 220, 222, with their own URL, just as the original recording was stored. They may also be related to one another through common or similar addresses or other methods. The original recording remains intact as well.

In operation, a user selects a recording for playback. Running the recording playback invokes the playback unit 310, which in turn invokes the dashboard 350, as described above. The dashboard 350 then retrieves data from the databases 220, 222 and populates its widgets 352, 354, 356, and 358. Importantly, the data retrieved from the databases 220, 222 during playback is updated data, and likely is not the same data that was present on the dashboard when the recording was created. Rather, the data that appears on the dashboard 350 during playback is the most current data that exists in the databases 220, 222

During playback, the recording takes control of the dashboard 350, just as if the user was operating it. For instance, with reference to FIGS. 1 and 3, when being created a particular interaction step converted the bar graph in the sales widget 130 of FIG. 1 to a line graph in a sales widget 356 of FIG. 3. When the same recording is replayed with the playback unit 310, the bar graph is likewise changed. Thus, running the recording creates the exact same dashboard state had the recording not been running, and the user of the dashboard 350 switched the format of the graph himself or herself.

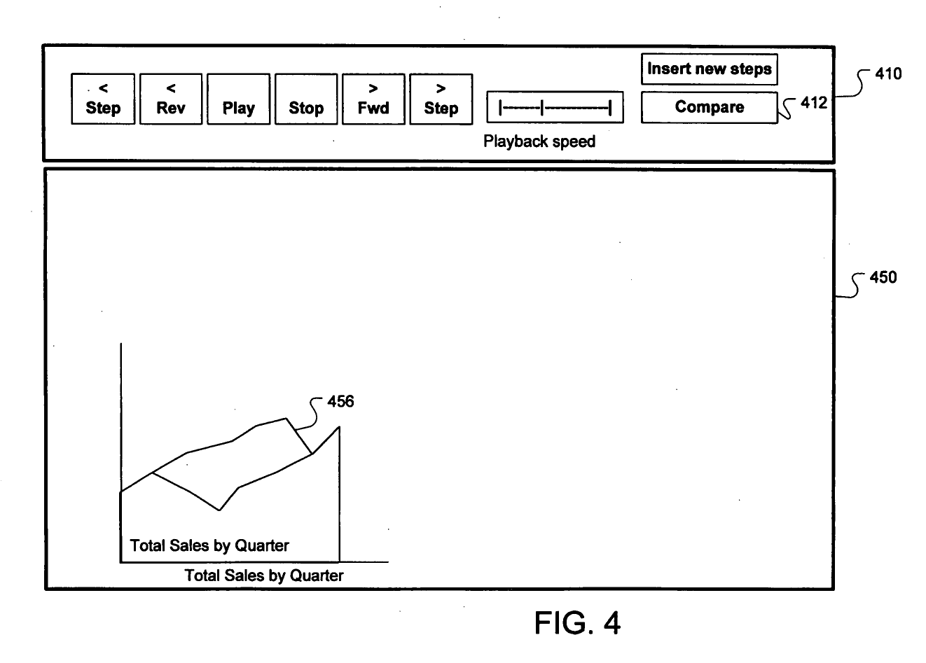

Because each interaction event in the recording is discrete, the user can pause playback at any particular event by using the control buttons 312. Further, the user may operate independently of the recording. In other words, the user may change the dashboard 350 while the recording being played is paused, and the dashboard 350 will correspondingly change even though the present recording did not cause the change. Such a change could be complementary to the recording playback or could interfere with it. In a complementary action, the user selects an action that does not interfere with the recording playback, such as expanding a size of a widget on the dashboard 350. An interfering action would conflict with the recording playback and could potentially cause inaccurate results. For instance, if the playback user selected a different employee during playback while the recording had an event specific to the originally selected employee, the recording may give an undefined result. In such a case the playback unit 310 may recognize that the user performed a conflicting event and warn or otherwise signal the user. More examples are described with reference to FIG. 4.

Also, because the interaction events in the recording are discrete, the user may stop them at any time and continue operating the dashboard 350 as if the recording had never been played. For instance, the user may stop the recording just before a report was to be generated, then apply an additional data filter. The user could then re-start the recording, or abandon the recording altogether, and operate the dashboard 350 “manually.” Because the recorded actions correspond directly to standard user interaction, the user can save the state of the dashboard at any point during playback, and return later to continue analysis.

Using embodiments of the invention different recordings may be run to configure the dashboard 350 to various starting modes. For instance, the user may create a recording to place the dashboard in a mode that makes generating reports relatively easy. Another recording may be specifically set up to allow easy comparison between data. In such uses of embodiments of the invention, a user may have a series of recordings readily available to quickly set the dashboard 350 to one of many useful configurations.

The discrete nature of the events in embodiments of the invention allows multiple users to collaborate, build, check and verify recordings that may be difficult or impossible for a single user to build. Each version of each recording can be separately stored in the repository 250 or elsewhere in the system 200 for later retrieval and operation.

In some embodiments, any parameters or controls specific to the playback user are maintained. For example, a user may have a security setting that does not allow viewing of financial data. Such a control does not interfere with the recording playback. Running a recording with the playback unit 310 continues to operate as normal, stepping through the recording events one by one. Any data that is filtered for the particular user does not affect the outcome of the recording. In this example, data that is above the security setting (financial data) is simply not displayed during playback, without affecting other portions of the recording playback.

The playback unit 310, as well as its components such as the control buttons 312, etc. may be rendered in HTML or DHTML, so they can be rendered on the same display screen as the dashboard 350.

FIG. 4 is a screen view that illustrates a comparison mode, which is a particular playback mode of a playback unit 410. In such a comparison mode, when a comparison function 412 is selected, the playback unit 410 determines differences in two recordings, then highlights the affect of the differences in a dashboard 450. For example, the recording described with respect to FIG. 1 converted the bar graph of the sales widget 130 into a line graph in FIG. 3. In the comparison example of FIG. 4, another recording adds data from a second employee and displays both sets of user data in a sales widget 456 of the dashboard 450.

In the comparison mode, the playback unit 410 displays only the widgets, or information in such widgets that is different between the compared modes. The dashboard 450 operating in this mode may blank out, grey out, or otherwise indicate to the user that no changes were made between widgets in both recordings. Thus, in FIG. 4 no other widgets appear in the dashboard 450 other than the sales widget 456 because all the other widgets are the same in the recordings being compared. Comparisons could also be displayed to the user in text form where the text representation of each recording, for example in an XML format, is shown side by side and the differences highlighted using different fonts and colors. Such a comparison feature can be very effective in sorting data and focusing only on relevant data.

In a related mode, conditional triggers can alert the user if the underlying data driving the dashboard changed. For example, the event recorder can include a condition that causes the playback unit to signal the user when data in the databases 220, 222 (FIG. 2) has been updated. One signal may simply be highlighting the changed data, or changing the background color. This feature is particularly helpful when the original annotation is dependent on specific data being present during playback. In other embodiments, conditional triggers or calculation triggers can be set, such as “if sales are greater than $100K, then proceed to choice A, otherwise, proceed to choice B.

A particular advantage of embodiments of the invention is that it operates in the same manner and using the same tools as the user is already using. For example, if the dashboard is displayed in a web browser window, the playback unit also displays in a browser window. Senders need not worry that receivers do not have the appropriate player, because the playback unit operates in the same tool as the dashboard itself.

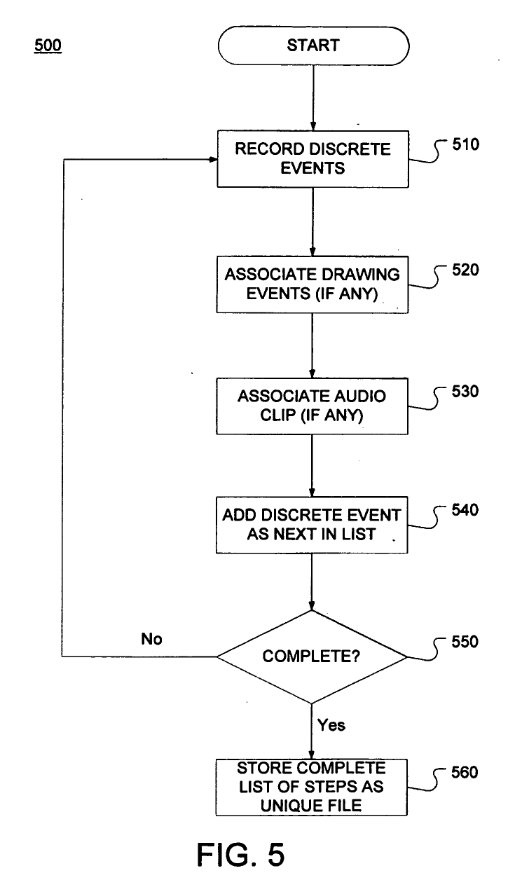

FIG. 5 is an example flow diagram illustrating a process 500 that the event recorder, such as the event recorder 230 of FIG. 2 may perform in creating an annotation. The event recorder 230 may be implemented as a stand-alone facility or in conjunction with a dashboard or other components. Further, the event recorder may be a series of instructions operating on a processor or server.

The event recorder 230 starts by generating and recording a first discrete user action in a process 510. The user action may be recorded as XML or in other form. In a process 520, any screen illustration is associated with the appropriate user action and likewise generated and recorded. Such screen illustration data may be expressed in Flash multimedia, HTML, DHTML, or other graphical expression, and may be anchored to a particular cell or an edge of the frame of the display window. A process 530 likewise associates audio data with any user action generated and recorded in the process 510. The audio data is likewise stored in an appropriate multimedia format playable by the Flash player or other players, and associated with such a user event action.

In a process 540, the collection of data generated and recorded in the processes 510, 520, and 530 is stored as a discrete event in a temporary data store. If the latest-stored event is determined in a process 550 to be the last event in the annotation, the entire annotation is stored in the repository 250 or elsewhere. A unique locator points to the stored file for later dissemination and retrieval. If instead there are additional events to record, the process 500 repeats until the last event is stored.

Users of embodiments of the invention have at their disposal much more powerful analysis tools than ever before. Analysis and annotations can be created, shared, edited, replicated and distributed to a variety of users for greater benefit. Recipients may create their own modified versions of such annotations or may use them to set up business intelligence dashboards for quick further analysis.

Although there has been described to this point particular embodiments of a system to record, distribute and playback interaction events, it is not intended that such specific references be considered as limitations upon the scope of this invention except in-so-far as set forth in the following claims.

What is claimed is:

1. An event interaction tracking facility for a user interface dashboard comprising:
a recorder structured to create a series of one or more discrete representations of user-controlled interactions with a first dashboard coupled to a first set of data, and to store the discrete representations in a list; and
a playback facility structured to control a second dashboard coupled to a second set of data, the playback facility further structured to select a discrete representation from the stored list and to recreate the associated interaction in the second dashboard.

2. The event interaction tracking facility of claim 1 in which the recorder further comprises:
a media generator structured to create a representation of a media event and to associate the media event with one of the one or more discrete representations of user-controlled interactions.

3. The event interaction tracking facility of claim 2 in which the media generator is structured to associate a visual cue coupled to a widget in the first dashboard.

4. The event interaction tracking facility of claim 2 in which the media generator is an audio generator.

5. The event interaction tracking facility of claim 1 in which the second dashboard is identical to the first dashboard.

6. The event interaction tracking facility of claim 1 in which the playback facility is structured to generate a visual signal on the second dashboard when a condition set against the first set of data is not met in the second set of data.

7. The event interaction tracking facility of claim 6 in which the condition is a comparison of a number in the second set of data to a fixed constant number.

8. The event interaction tracking facility of claim 1 in which the playback facility is structured to invoke the recorder after one or more of the discrete representations have been recreated on the second dashboard to create a branch version of the discrete representations.

9. A computer-controlled method to create a playable event history, comprising:
storing a collection of individual events of interactions with a first dashboard coupled to a first set of data;
identifying the stored collection with a unique address;
retrieving the stored collection by the unique address; and
recreating the collection of individual events of interactions on a second dashboard coupled to a second set of data.

10. The method of claim 9, further comprising:
associating a visual cue with one of the individual events.

11. The method of claim 9 in which recreating the collection of individual events of interactions comprises operating the second dashboard as if it were controlled by an interactive user.

12. The method of claim 9 in which recreating the collection of individual events of interactions on the second dashboard comprises sequentially stepping through the individual events.

13. The method of claim 9 in which recreating the collection of individual events of interactions on the second dashboard has no affect on content controls set for the second dashboard.

14. The method of claim 9, further comprising:
storing a second collection of individual events including interactions with the first dashboard and interactions with the second dashboard.

15. The method of claim 9, further comprising:
generating an alert based on an interaction event applied to the second set of data.

16. A system, comprising:
a first dashboard coupled to a first set of data;
a recorder structured to store a collection of events as discrete units as they are performed on the first dashboard; and
an event playback facility structured to retrieve the collection of events and execute the retrieved events on a second dashboard.

17. The system of claim 16, further comprising a condition stored in the collection of events that, when compared against a second set of data coupled to the second dashboard, causes a signal on the second dashboard to be generated.

18. The system of claim 16, in which the recorder further comprises an interaction tracking facility structured to attach an annotation to a widget on the first dashboard.

19. The system of claim 16, in which the event playback facility is structured to individually step through the collection of discrete units.

20. The system of claim 16, in which a selection on the playback facility causes the recorder to record a collection of events as discrete units as they are performed on the second dashboard.
